(19) United States
(12) Patent Application Publication
(10) Pub. No.: US 2023/0041356 A1
(43) Pub. Date: Feb. 9, 2023

(54) BATTERY

(71) Applicant: Prime Planet Energy & Solutions, Inc., Tokyo (JP)

(72) Inventor: Tetsuji OMURA, Kobe-shi (JP)

(21) Appl. No.: 17/878,909

(22) Filed: Aug. 2, 2022

(30) Foreign Application Priority Data
Aug. 3, 2021 (JP) 2021-127604

(51) Int. Cl. H01M 50/264; H01M 50/209; H01M 10/613; H01M 10/6567; H01M 10/647; H01M 10/6554; H01M 10/6556

(52) U.S. Cl. CPC H01M 50/264; H01M 50/209; H01M 10/613; H01M 10/6567; H01M 10/647; H01M 10/6554; H01M 10/6556

(57) ABSTRACT

A stack has an end surface located at an end portion in a first direction. A restraint portion includes a first member, a second member, and an adhesive agent layer. The first member has a main body portion and a protrusion portion. The protrusion portion protrudes from the main body portion in a second direction intersecting the first direction. The second member is provided with a recess portion that receives at least a portion of the protrusion portion in the second direction. The adhesive agent layer adheres the first member and the second member to each other. One of the first member and the second member is provided to face the end surface of the stack. The protrusion portion and the recess portion are engaged with each other with the adhesive agent layer being interposed between the protrusion portion and the recess portion.

This nonprovisional application is based on Japanese Patent Application No. 2021-127604 filed on Aug. 3, 2021 with the Japan Patent Office, the entire contents of which are hereby incorporated by reference.

### BACKGROUND OF THE INVENTION

### Field of the Invention

The present technology relates to a battery.

### Description of the Background Art

Japanese Patent Laying-Open No. 2020-129474 is a prior art document that discloses a configuration of a battery pack. The battery pack described in Japanese Patent Laying-Open No. 2020-129474 includes a battery stack and a pack case. The pack case compresses the battery stack in the stacking direction and accommodates the battery stack. The pack case includes a metal case member and a resin case member. The metal case member has a first side wall metal plate portion and a third side wall metal plate portion. The resin case member includes a corner joining resin portion. The first sidewall metal plate portion has an inner metal plate portion. The third side wall metal plate portion has an extending portion. The extending portion is engaged with the inner metal plate portion with the corner joining resin portion being interposed in the stacking direction of the battery stack.

### SUMMARY OF THE INVENTION

Members of a restraint portion that restrains a plurality of power storage cells may be connected to each other by an adhesive agent. In this case, the adhesive agent may be deteriorated due to influence of heat generated from a plurality of power storage cells or absorption of moisture present therearound, with the result that proof stress of the restraint portion may be decreased.

The present disclosure has been made to solve the above-described problem, and has an object to provide a battery, in which strength of connection between members of a restraint portion can be improved to improve proof stress of the restraint portion.

A battery according to the present technology includes a stack and a restraint portion. The stack includes a plurality of power storage cells stacked in a first direction, and has an end surface located at an end portion in the first direction. The restraint portion restrains the stack in the first direction. The restraint portion includes a first member, a second member, and an adhesive agent layer. The first member has a main body portion and a protrusion portion. The protrusion portion protrudes from the main body portion in a second direction intersecting the first direction. The second member is provided with a recess portion that receives at least a portion of the protrusion portion in the second direction. The adhesive agent layer adheres the first member and the second member to each other. One of the first member and the second member is provided to face the end surface of the stack. The protrusion portion and the recess portion are engaged with each other with the adhesive agent layer being interposed between the protrusion portion and the recess portion.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing a configuration of a battery according to a first embodiment of the present technology.

FIG. 2 is a perspective view showing configurations of power storage cells and end plates included in the battery according to the first embodiment of the present technology.

FIG. 3 is a perspective view showing a configuration of a power storage cell included in the battery according to the first embodiment of the present technology.

FIG. 4 is a cross sectional view of the battery of FIG. 1 when viewed in a direction of arrowed line IV-IV.

FIG. 5 is a cross sectional view showing the configuration of the battery with a V portion in FIG. 4 being enlarged.

FIG. 6 is a cross sectional view showing a configuration of a battery according to a comparative example.

FIG. 7 is a cross sectional view showing a configuration of a battery according to a second embodiment of the present technology.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly.

It should be noted that in the present specification, the terms “comprise”, “include”, and “have” are open-end terms. That is, when a certain configuration is included, a configuration other than the foregoing configuration may or may not be included. Further, the present technology is not limited to one that necessarily exhibits all the functions and effects stated in the present embodiment.

In the present specification, the term “battery” is not limited to a lithium ion battery, and may include another battery such as a nickel-metal hydride battery. In the present specification, the term “electrode” may collectively represent a positive electrode and a negative electrode. Further, the term “electrode plate” may collectively represent a positive electrode plate and a negative electrode plate.

In the present specification, the “power storage cell” or the “power storage module” is not limited to a battery cell or a battery module, and may include a capacitor cell or a capacitor module.

It should be noted that in the figures, a direction in which a protrusion portion of a first member protrudes is defined as an X direction that serves as a second direction, a stacking direction of power storage cells is defined as a Y direction that serves as a first direction, and a direction intersecting the first direction and the second direction is defined as a Z direction that serves as a third direction.

### First Embodiment

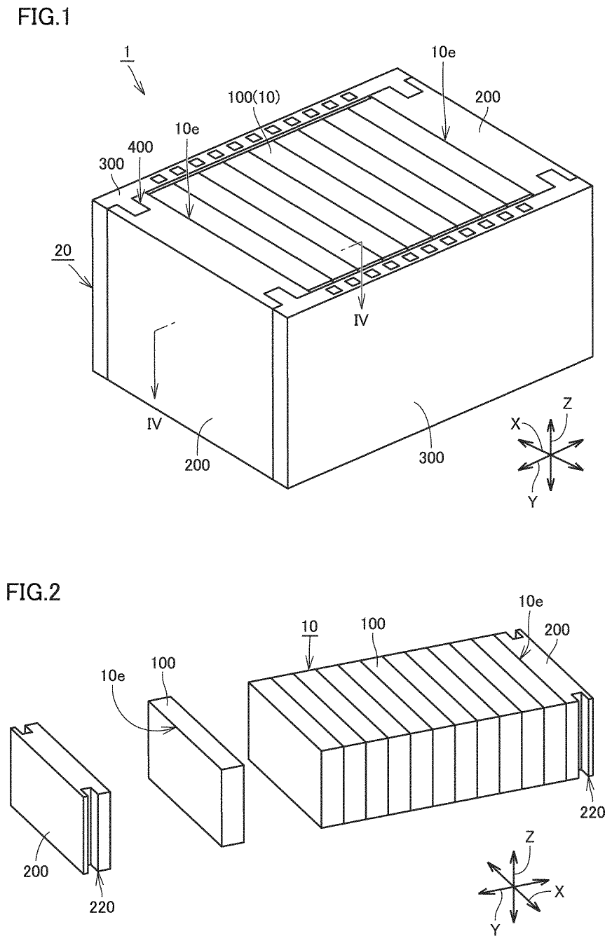

FIG. 1 is a perspective view showing a configuration of a battery according to a first embodiment of the present technology. FIG. 2 is a perspective view showing configurations of power storage cells and end plates included in the battery according to the first embodiment of the present technology.

As shown in FIGS. 1 and 2, a battery 1 according to a first embodiment of the present technology includes a stack 10 and a restraint portion 20.

In stack 10, a plurality of power storage cells 100 are stacked side by side in the first direction (Y direction). Stack 10 has end surfaces 10e located at end portions in the first direction (Y direction). A separator (not shown) is interposed between power storage cells 100.

Restraint portion 20 restrains stack 10 in the first direction (Y direction). Restraint portion 20 includes a first member, a second member, and an adhesive agent layer 400. In the present embodiment, the first member represents restraint members 300, and the second member represent end plates 200.

One of the first member and the second member is provided to face end surface 10e of stack 10. In the present embodiment, each of end plates 200 is provided to face end surface 10e of stack 10.

End plates 200 are provided at both ends of stack 10 in the Y direction. Two end plates 200 sandwich stack 10. Two end plates 200 press stack 10 in the Y direction to restrain stack 10 between end plates 200.

Each of end plates 200 is composed of, for example, aluminum or steel. End plate 200 is formed by, for example, extrusion.

The other of the first member and the second member is provided along the first direction (Y direction). In the present embodiment, restraint members 300 are provided at ends of stack 10 and end plates 200 in the X direction.

Each of restraint members 300 is composed of, for example, aluminum or steel. Restraint member 300 is formed by, for example, extrusion.

Adhesive agent layer 400 is disposed between restraint member 300 and end plate 200. Adhesive agent layer 400 adheres restraint member 300 and end plate 200 to each other. Adhesive agent layer 400 is composed of, for example, an epoxy resin. It should be noted that restraint member 300 and end plate 200 in restraint portion 20 of the present embodiment are connected to each other by adhesive agent layer 400; however, it is not limited to this configuration, and a different connection, such as bolt fastening or welding, may be applied.

When restraint member 300 is engaged with end plates 200 with compressive force in the Y direction being applied to the plurality of stacked power storage cells 100 and end plates 200 and then the compressive force is released, tensile force acts on restraint member 300 that connects two end plates 200. As a reaction thereto, restraint member 300 presses two end plates 200 in directions of bringing them closer to each other. As a result, restraint portion 20 restrains stack 10 in the Y direction.

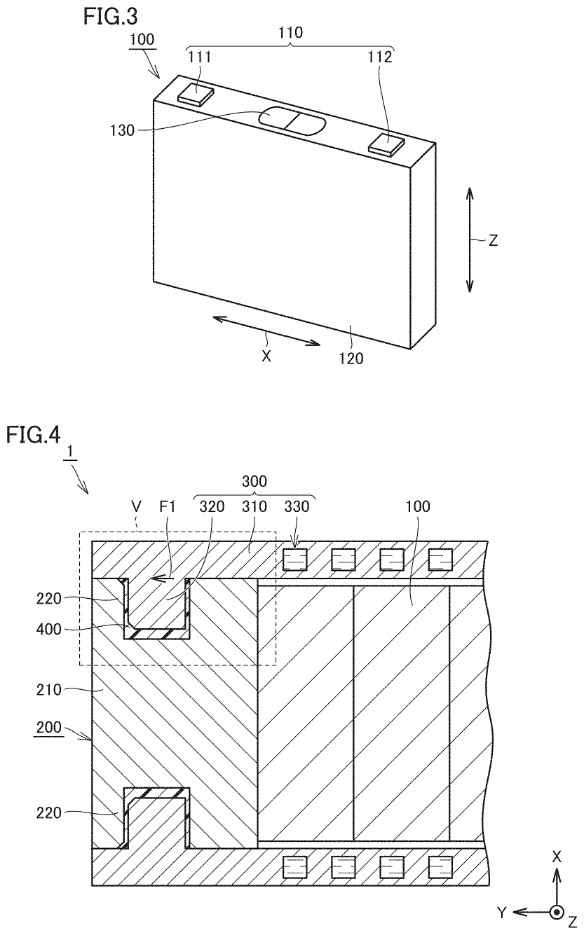

FIG. 3 is a perspective view showing a configuration of a power storage cell included in the battery according to the first embodiment of the present technology. As shown in FIG. 3, power storage cell 100 includes an electrode terminal 110, an exterior package 120, and a gas discharge valve 130.

Electrode terminal 110 includes a positive electrode terminal 111 and a negative electrode terminal 112. Electrode terminal 110 is formed on exterior package 120. Exterior package 120 is formed to have a substantially rectangular parallelepiped shape. An electrode assembly (not shown) and an electrolyte solution (not shown) are accommodated in exterior package 120. Gas discharge valve 130 is fractured when pressure inside exterior package 120 becomes equal to or more than a predetermined value. Thus, gas in exterior package 120 is discharged to the outside of exterior package 120.

FIG. 4 is a cross sectional view of the battery of FIG. 1 when viewed in a direction of arrowed line IV-IV. FIG. 5 is a cross sectional view showing the configuration of the battery with a V portion in FIG. 4 being enlarged.

As shown in FIGS. 4 and 5, each restraint member 300 includes a main body portion 310, a protrusion portion 320, and flow path portions 330.

Main body portion 310 is a plate-shaped member extending in the Y direction. As shown in FIG. 5, main body portion 310 has an end surface portion 311 on the end plate 200 side.

Protrusion portion 320 protrudes from main body portion 310 in the second direction (X direction) intersecting the first direction (Y direction). Protrusion portion 320 has first surface portions 321, a root portion 320r, and a first tapered portion 322. Protrusion portion 320 and main body portion 310 are formed in one piece by extrusion. It should be noted that main body portion 310 and protrusion portion 320 may be formed by welding separate members to each other.

First surface portions 321 extend along the second direction (X direction). The pair of first surface portions 321 are provided at both ends of protrusion portion 320 in the Y direction. Specifically, in the Y direction of protrusion portion 320, one first surface portion 321a is provided on the power storage cell 100 side, and other first surface portion 321b is provided on the side opposite to the power storage cell 100 side.

Root portion 320r is a portion of protrusion portion 320 located on the main body portion 310 side. First tapered portion 322 is disposed at the tip of other first surface portion 321b on the end plate 200 side.

End plate 200 has a main body portion 210 and is provided with recess portions 220. Main body portion 210 is a plate-shaped member extending in the X direction.

Each of recess portions 220 receives at least a portion of protrusion portion 320 in the second direction (X direction). In the present embodiment, recess portion 220 receives a whole of protrusion portion 320.

Recess portion 220 has a first segment portion 230, a second segment portion 240, a bottom surface portion 223, and a second tapered portion 241. First segment portion 230 is located on the power storage cell 100 side with respect to the recessed shape of recess portion 220. Second segment portion 240 is located on the side opposite to power storage cell 100 with respect to the recessed shape of recess portion 220. Each of first segment portion 230 and second segment portion 240 is provided with a tip portion 221 on the restraint member 300 side. Bottom surface portion 223 is located on the end portion side of main body portion 210 in the X direction.

Each of first segment portion 230 and second segment portion 240 is provided with a second surface portion 222 on the protrusion portion 320 side. Specifically, one second surface portion 222a is provided on the protrusion portion 320 side of first segment portion 230, and other second surface portion 222b is provided on the protrusion portion 320 side of second segment portion 240. Second surface portion 222 extends along the second direction (X direction) and faces first surface portion 321. The recessed shape of recess portion 220 is defined by tip portions 221, second surface portions 222, and bottom surface portion 223.

Second tapered portion 241 is disposed on the tip portion 221 side of other second surface portion 222b. By providing first tapered portion 322 and second tapered portion 241, protrusion portion 320 is facilitated to be inserted into recess portion 220 when engaging protrusion portion 320 and recess portion 220 with each other. Further, since first tapered portion 322 and second tapered portion 241 are located on the side opposite to power storage cell 100 when viewed from the center of protrusion portion 320, bending moment applied to root portion 320r due to load from power storage cells 100 can be made small at a portion at which one first surface portion 321a and one second surface portion 222a, which receive the load, are adhered face to face each other, with the result that the strength of protrusion portion 320 in the load direction (Y direction) can be increased.

As shown in FIG. 5, in the second direction (X direction), a depth D1 of recess portion 220 is deeper than a protruding height W of protrusion portion 320 from main body portion 310. Thus, protrusion portion 320 is not in contact with bottom surface portion 223. It should be noted that depth DI of recess portion 220 and protruding height W of protrusion portion 320 may be the same. Further, in the X direction, first segment portion 230 and second segment portion 240 included in recess portion 220 preferably have the same length, or first segment portion 230 is preferably longer than second segment portion 240. With this configuration, the bending moment applied to root portion 320r due to the load from power storage cells 100 can be made small at the portion at which one first surface portion 321a and one second surface portion 222a that receive the load are adhered face to face each other, with the result that the strength of protrusion portion 320 in the load direction (Y direction) can be increased.

Main body portion 310 of restraint member 300 is in direct abutment with end plate 200. Specifically, end surface portion 311 of main body portion 310 and tip portion 221 of recess portion 220 are in direct contact with each other. That is, adhesive agent layer 400 is not interposed between end surface portion 311 and tip portion 221. Thus, the size of restraint portion 20 in the X direction is not affected by adhesive agent layer 400.

As shown in FIG. 4, cooling water can flow through flow path portions 330. The plurality of flow path portions 330 are disposed side by side in the Y direction of main body portion 310.

Flow path portions 330 are separated from protrusion portion 320 and recess portion 220 in the first direction (Y direction). Specifically, flow path portions 330 in the present embodiment are disposed at positions not beside end plate 200 in the X direction, and are therefore separated from protrusion portion 320 and recess portion 220.

Flow path portions 330 are disposed along the third direction (Z direction) intersecting the first direction (Y direction) and the second direction (X direction). It should be noted that flow path portions 330 may be disposed along the Y direction. However, when flow path portions 330 are disposed along the Y direction, flow path portions 330 are disposed to intersect the extending direction (Z direction) of protrusion portion 320, so that either protrusion portion 320 or flow path portions 330 is/are desirably provided by a manufacturing method other than extrusion such as cutting.

As shown in FIG. 5, protrusion portion 320 and recess portion 220 are engaged with each other with adhesive agent layer 400 being interposed between protrusion portion 320 and recess portion 220. Specifically, in the present embodiment, one first surface portion 321a and one second surface portion 222a face each other, and other first surface portion 321b and other second surface portion 222b face each other, with the result that protrusion portion 320 and recess portion 220 are engaged with each other with adhesive agent layer 400 being interposed between protrusion portion 320 and recess portion 220.

Thickness t1 of first segment portion 230 in the Y direction is larger than thickness t3 of second segment portion 240 in the Y direction. Thickness t2 of protrusion portion 320 in the Y direction is thicker than thickness t3 of second segment portion 240 in the Y direction. Thus, respective thicknesses t1, t2 of first segment portion 230 and protrusion portion 320 each fed with load from power storage cells 100 are desirably thicker than thickness t3 of second segment portion 240.

Here, a comparative example to the battery according to the first embodiment of the present technology will be described. Since the battery according to the comparative example is different from the battery according to the first embodiment of the present technology in terms of the configuration of the end plate, the same configurations as those of the battery according to the first embodiment of the present technology will not be described repeatedly.

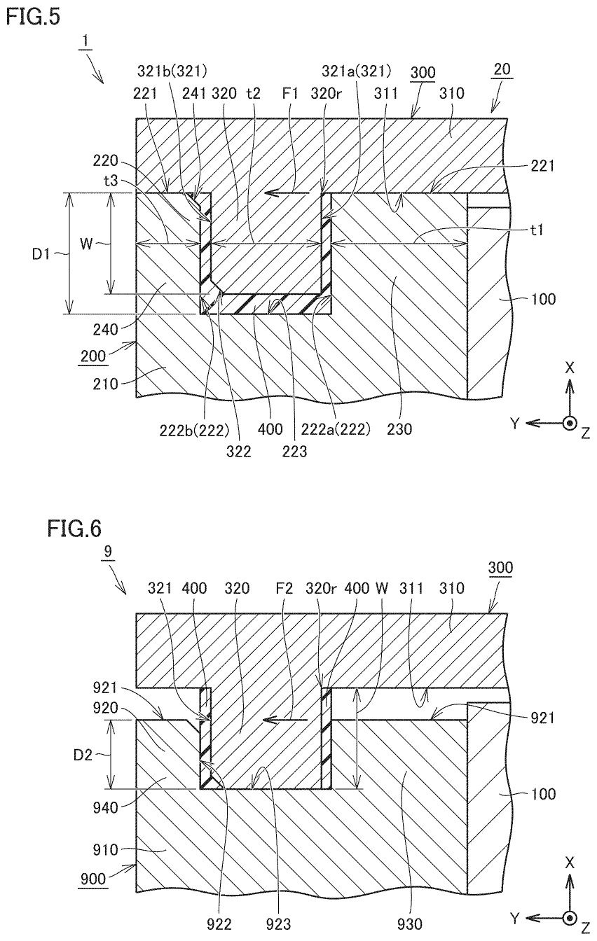

FIG. 6 is a cross sectional view showing a configuration of the battery according to the comparative example. As shown in FIG. 6, a battery 9 according to the comparative example of the present technology includes: a stack in which power storage cells 100 are stacked in the Y direction; and a restraint portion. The restraint portion includes restraint members 300, end plates 900, and an adhesive agent layer 400.

Each of end plates 900 has a main body portion 910 and is provided with recess portions 920. Each of recess portions 920 receives a tip portion of protrusion portion 320.

Recess portion 920 has a first segment portion 930, a second segment portion 940, and a bottom surface portion 923. Each of first segment portion 930 and second segment portion 940 is provided with a tip portion 921 on the restraint member 300 side. In this comparative example, tip portion 921 is not in contact with end surface portion 311. Each of first segment portion 930 and second segment portion 940 is provided with a second surface portion 922 on the protrusion portion 320 side.

In the second direction (X direction), a depth D2 of recess portion 920 is shallower than a protruding height W of protrusion portion 320 from main body portion 310. Protrusion portion 320 is in direct abutment with bottom surface portion 923. Protrusion portion 320 and recess portion 920 are engaged with each other at first surface portions 321 and second surface portions 922 with adhesive agent layer 400 being interposed between protrusion portion 320 and recess portion 920.

If power storage cells 100 are expanded in the Y direction, load from power storage cells 100 is applied to end plate 900. The load applied to end plate 900 is propagated to apply load F2 from end plate 900 to restraint member 300. Since end surface portion 311 and tip portion 921 are not in abutment with each other, load F2 is applied to protrusion portion 320 at a position away from root portion 320r in the X direction. Accordingly, load F2 is applied to protrusion portion 320 as bending moment, with the result that proof stress of protrusion portion 320 against load F2 may be decreased.

On the other hand, in the present embodiment, as shown in FIG. 5, since depth D1 of recess portion 220 is deeper than projection height W of protrusion portion 320 from main body portion 310 in the X direction, end surface portion 311 of main body portion 310 is in abutment with tip portion 221 of recess portion 220, so that when load in the Y direction is applied from power storage cells 100, load Fl in the Y direction is applied to protrusion portion 320 at root portion 320r. That is, load Fl is applied to protrusion portion 320 in the shearing direction (Y direction). Accordingly, load Fl is suppressed from being applied to protrusion portion 320 as bending moment.

In battery 1 according to the first embodiment of the present technology, since restraint member 300 and end plate 200 are adhered to each other by adhesive agent layer 400 and protrusion portion 320 and recess portion 220 are engaged with each other, strength of connection can be increased between the members of restraint portion 20 to improve the proof stress of restraint portion 20 as compared with a case where restraint member 300 and end plate 200 are connected to each other only by adhesive agent layer 400 without providing protrusion portion 320 and recess portion 220.

In battery 1 according to the first embodiment of the present technology, since depth D1 of recess portion 220 is deeper than protruding height W of protrusion portion 320, load resulting from expansion of the plurality of power storage cells 100 can be applied to protrusion portion 320 in the shearing direction (Y direction), thereby improving the proof stress of restraint portion 20.

In battery 1 according to the first embodiment of the present technology, since main body portion 310 of restraint member 300 is in direct abutment with end plate 200, load resulting from expansion of the plurality of power storage cells 100 can be applied to protrusion portion 320 in the shearing direction (Y direction), thereby improving the proof stress of restraint portion 20.

In battery 1 according to the first embodiment of the present technology, since restraint member 300 and end plate 200 are connected to each other by adhesive agent layer 400, it is not necessary to provide a hole or a weld portion in a constituent member when providing flow path portions 330 as compared with a case where restraint member 300 and end plate 200 are connected to each other by welding or bolt fastening, with the result that flow path portions 330 can be readily disposed inside restraint member 300

In battery 1 according to the first embodiment of the present technology, since flow path portions 330 are separated from protrusion portion 320 and recess portion 220 in the first direction (Y direction) and are disposed along the third direction (Z direction), a cooling structure can be provided in restraint member 300 serving as the first member while suppressing influence of the load resulting from expansion of power storage cells 100 over flow path portions 330.

In battery 1 according to the first embodiment of the present technology, since each of restraint member 300 and end plate 200 is formed by extrusion, protrusion portion 320 and recess portion 220 can be efficiently provided.

### Second Embodiment

Hereinafter, a battery according to a second embodiment of the present technology will be described. Since the battery according to the second embodiment of the present technology is different from battery 1 according to the first embodiment of the present technology in terms of the configuration of the restraint portion, the same configurations as those of battery 1 according to the first embodiment of the present technology will not be described repeatedly.

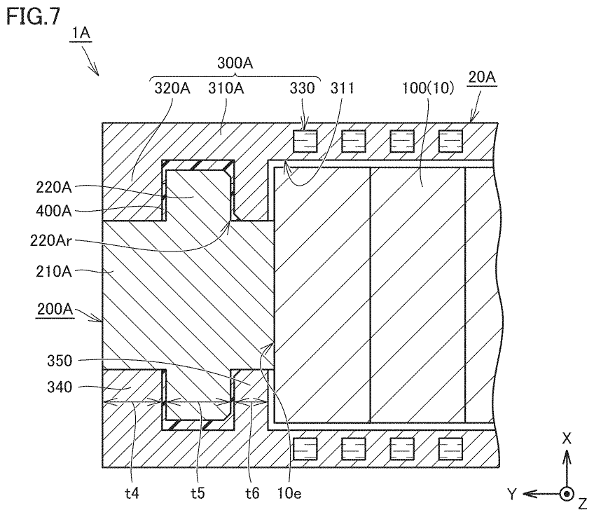

FIG. 7 is a cross sectional view showing a configuration of a battery according to a second embodiment of the present technology. As shown in FIG. 7, a battery 1A according to the second embodiment includes a stack 10 and a restraint portion 20A. Restraint portion 20A includes a first member, a second member, and an adhesive agent layer 400A. In the present embodiment, the first member represents end plates 200A, and the second member represents restraint members 300A.

Each of end plates 200A is provided to face an end surface 10e of stack 10. Restraint members 300A are provided at ends of stack 10 and end plates 200A in the X direction. Adhesive agent layer 400A is disposed between restraint member 300A and end plate 200A.

End plate 200A has a main body portion 210A and protrusion portions 220A. Each of protrusion portions 220A protrudes from main body portion 210A in the X direction. Protrusion portion 220A has a root portion 220Ar. Main body portion 210A and protrusion portion 220A are formed in one piece by extrusion or are formed by welding separate members to each other.

Restraint member 300A has a main body portion 310A, is provided with a recess portion 320A, and has flow path portions 330. Recess portion 320A receives a whole of protrusion portion 220A.

Recess portion 320A has a first segment portion 340 and a second segment portion 350. First segment portion 340 is located on the side opposite to power storage cells 100 with respect to the recessed shape of recess portion 320A. Second segment portion 350 is located on the power storage cell 100 side with respect to the recessed shape of recess portion 320A. Protrusion portion 220A and recess portion 320A are engaged with each other with adhesive agent layer 400 being interposed between protrusion portion 220A and recess portion 320A.

Thickness t4 of first segment portion 340 in the Y direction is larger than thickness t6 of second segment portion 350 in the Y direction. Thickness t5 of protrusion portion 220A in the Y direction is thicker than thickness t6 of second segment portion 350 in the Y direction. Thus, respective thicknesses t4, t5 of first segment portion 340 and protrusion portion 220A each fed with load from power storage cell 100 are desirably thicker than thickness t6 of second segment portion 350.

In the X direction, the length of first segment portion 340 can be longer than the length of second segment portion 350. Thus, since the whole of protrusion portion 220A is securely received on the first segment portion 340 side to which load is applied, bending moment applied to protrusion portion 220A can be made small, thereby improving the proof stress of restraint portion 20A.

In battery 1A according to the second embodiment of the present technology, since main body portion 210A and protrusion portion 220A of end plate 200A are formed in one piece by extrusion or are formed by welding separate members to each other, the position of protrusion portion 220A with respect to main body portion 210A can be readily changed.

It should be noted that the first member and the second member included in the restraint portion are represented by an end plate and a binding bar in the above-described embodiments; however, it is not limited to this configuration. The first member and the second member included in the restraint portion may be, for example, one side surface and the other side surface of the housing of the battery.

Although the embodiments of the present invention have been described and illustrated in detail, it is clearly understood that the same is by way of illustration and example only and is not to be taken by way of limitation, the scope of the present invention being interpreted by the terms of the appended claims. The scope of the present invention is defined by the terms of the claims, and is intended to include any modifications within the scope and meaning equivalent to the terms of the claims.

What is claimed is:

1. A battery comprising:
a stack in which a plurality of power storage cells are stacked in a first direction, the stack having an end surface located at an end portion in the first direction; and
a restraint portion that restrains the stack in the first direction, wherein
the restraint portion includes
a first member having a main body portion and a protrusion portion that protrudes from the main body portion in a second direction intersecting the first direction,
a second member provided with a recess portion that receives at least a portion of the protrusion portion in the second direction, and
an adhesive agent layer that adheres the first member and the second member to each other,
one of the first member and the second member is provided to face the end surface of the stack, and
the protrusion portion and the recess portion are engaged with each other with the adhesive agent layer being interposed between the protrusion portion and the recess portion.

2. The battery according to claim 1, wherein in the second direction, a depth of the recess portion is deeper than a protruding height of the protrusion portion from the main body portion.

3. The battery according to claim 1, wherein the main body portion of the first member is in direct abutment with the second member.

4. The battery according to claim 2, wherein the main body portion of the first member is in direct abutment with the second member.

5. The battery according to claim 1, wherein
the other of the first member and the second member is provided along the first direction, and
the other of the first member and the second member includes a flow path portion through which cooling water is able to flow.

6. The battery according to claim 2, wherein
the other of the first member and the second member is provided along the first direction, and
the other of the first member and the second member includes a flow path portion through which cooling water is able to flow.

7. The battery according to claim 3, wherein
the other of the first member and the second member is provided along the first direction, and
the other of the first member and the second member includes a flow path portion through which cooling water is able to flow.

8. The battery according to claim 4, wherein
the other of the first member and the second member is provided along the first direction, and
the other of the first member and the second member includes a flow path portion through which cooling water is able to flow.

9. The battery according to claim 5, wherein the flow path portion is separated from the protrusion portion and the recess portion in the first direction and is disposed along a third direction intersecting the first direction and the second direction.

10. The battery according to claim 6, wherein the flow path portion is separated from the protrusion portion and the recess portion in the first direction and is disposed along a third direction intersecting the first direction and the second direction.

11. The battery according to claim 7, wherein the flow path portion is separated from the protrusion portion and the recess portion in the first direction and is disposed along a third direction intersecting the first direction and the second direction.

12. The battery according to claim 8, wherein the flow path portion is separated from the protrusion portion and the recess portion in the first direction and is disposed along a third direction intersecting the first direction and the second direction.

13. The battery according to claim 1, wherein each of the first member and the second member is formed by extrusion.

14. The battery according to claim 1, wherein the main body portion and the protrusion portion are formed by welding separate members to each other.
